(19) United States
(12) Patent Application Publication
(10) Pub. No.: US 2009/0252114 A1
(43) Pub. Date: Oct. 8, 2009

(54) Method and System for Supporting Seamless Handover of Mobile Node Using Mobile Stream Control Transmission Protocol

(75) Inventors: Yong Geun Hong, Daejeon-city (KR); Jung Soo Park, Daejeon-city (KR); Hyoung Jun Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Deajeon (KR)

(21) Appl. No.: 12/085,570

(22) PCT Filed: Dec. 6, 2006
(86) PCT No.: PCT/KR2006/005239

§ 371 Date: May 28, 2008

(30) Foreign Application Priority Data
Dec. 8, 2005 (KR) 10-2005-0119302
Aug. 21, 2006 (KR) 10-2006-0078978

(51) Int. Cl. H04W 36/00

(52) U.S. Cl. 370/331

(57) ABSTRACT

A method and system for supporting a seamless handover of a mobile node using a mobile Stream Control Transmission Protocol (mSCTP) to support the mobility of the mobile node are provided. In the method and system, a change in data link layer information, which occurs when the mobile node moves into a new sub-network, is detected and changed data link layer information is transmitted to a network layer. A new Internet protocol (IP) address for the new sub-network is acquired in the network layer using the changed data link layer information. The new IP address is transmitted to a transport layer and dynamic address setting is performed in the transport layer using the mSCTP.

### CROSS-REFERENCE TO RELATED PATENT APPLICATIONS

This application claims the benefit of Korean Patent Application No. 10-2005-0119302, filed on Dec. 8, 2005 and Korean Patent Application No. 10-2006-0078978, filed on Aug. 21, 2006, in the Korean Intellectual Property Office, the disclosures of which are incorporated herein in their entirety by reference.

### BACKGROUND OF THE INVENTION

1. Field of the Invention

The present invention relates to a method and system for supporting mobility of a mobile node, and more particularly, to a method and system for supporting a seamless handover of a mobile node using a mobile Stream Control Transmission Protocol (mSCTP).

2. Description of the Related Art

As a wired and wireless combined network based on the All-Internet Protocol (IP) has been developed as a next generation communication network, there is increased demand for IP mobility. As Wireless Broadband (WiBro) services based on the Institute of Electrical and Electronics Engineers (IEEE) 802.16 standard are increasingly provided together with a Wireless Local Area Network (WLAN), third generation (3G) mobile communication, and a cellular system, the necessity of IP mobility has increased more and more. However, since the mobility of terminals is not considered in conventional Internet environments, various problems may occur when terminals are mobile. Many approaches for supporting the mobility of terminals have been proposed, an example of which is a mobile IP. Recently, a mobile Stream Control Transmission Protocol (mSCTP) has been suggested.

The mSCTP is based on the SCTP suggested by the signaling transport (SIGTRAN) working group (WG) of the Internet Engineering Task Force (IETF), which is a body that defines Internet standards. The mSCTP uses AddIP and DeleteIP, which allow IP addresses mapped in an SCTP association to be dynamically changed, in order to support mobility. AddIP and DeleteIP are messages defined in IETF Internet standards, and more particularly, in an IETF document entitled “Stream Control Transmission Protocol (SCTP) Dynamic Address Reconfiguration (draft-ietf-tsvwg-addip-sctp-14.txt)”.

AddIP adds a new IP address to the SCTP association and DeleteIP deletes an IP address registered as an end IP address in a current association. When a mobile node moves into a new sub-network and acquires a new IP address, a counter node adds the new IP address to a current SCTP association using AddIP and deletes an old IP address used in a previous sub-network, in which data transmission is now impossible, using DeleteIP.

The mSCTP facilitates a handover by binding a changed IP address to a session so that the session is not interrupted even if an IP address is changed due to the movement of a mobile node, that is, the mSCTP seamlessly maintains the connection between the mobile node and the Internet.

However, a point when AddIP is started after a mobile node moves into a new sub-network is just considered a point when a new IP address is acquired, but there is no special mechanism for acquiring a new IP address. How quickly a mobile node acquires a new IP address when it moves into a new network is very essential to the entire handover performance. Accordingly, it is very important to acquire a new IP address and start AddIP as quickly as possible.

An mSCTP technique for supporting the mobility of a mobile device between non-intersecting networks is disclosed in U.S. Patent No. 2005/0073981, entitled “mSCTP Based Handover of a Mobile Device between Non-Intersecting Networks”. However, this technique does not provide a method and system for defining an exact AddIP point of time and reducing handover time. In addition, a mechanism for supporting mobility in different environments using SCTP is disclosed in an IEEE wireless communication paper, entitled “A New Method to Support UMTS/WLAN Vertical Handover Using SCTP”, but a method of reducing handover time is not provided.

### SUMMARY OF THE INVENTION

The present invention provides a method and system for supporting a seamless handover of a mobile node using a mobile Stream Control Transmission Protocol (mSCTP) by reducing a handover delay occurring when the mobile node moves into a new sub-network.

According to an aspect of the present invention, there is provided a method of supporting a seamless handover of a mobile node using a mobile Stream Control Transmission Protocol (mSCTP), the method including: detecting a change of data link layer information, which occurs when the mobile node moves into a new sub-network, and transmitting changed data link layer information to a network layer; acquiring a new Internet protocol (IP) address for the new sub-network in the network layer based on the changed data link layer information; and transmitting the new IP address to a transport layer and performing dynamic address setting in the transport layer using the mSCTP.

According to another aspect of the present invention, there is provided a A system for supporting a seamless handover of a mobile node using a mobile Stream Control Transmission Protocol (mSCTP), the system including: a change detector detecting a change of data link layer information, which occurs when the mobile node moves into a new sub-network and transmitting changed data link layer information to a network layer; a sub-network determination unit determining whether the mobile node has moved into the new sub-network based on the changed data link layer information; an Internet protocol (IP) address acquisition unit acquiring a new IP address for the new sub-network based on the changed data link layer information; and a dynamic address setting unit changing an address of the mobile node into the new IP address using the mSCTP while maintaining a session.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the typical operation of a mobile Stream Control Transmission Protocol (mSCTP) for supporting mobility of a mobile node;

FIG. 2 illustrates the change of Internet Protocol (IP) addresses when the mobile node illustrated in FIG. 1 moves into a new sub-network;

FIG. 3 is a method of supporting a seamless handover of a mobile node using the mSCTP according to an embodiment of the present invention;

FIG. 4 illustrates a procedure of transmitting information between layers and performing a function in a mobile node, according to an embodiment of the present invention; and

FIG. 5 illustrates a system for supporting a seamless handover of a mobile node using the mSCTP according to an embodiment of the present invention.

### DETAILED DESCRIPTION OF THE INVENTION

Hereinafter, preferred embodiments of the present invention will be described in detail with reference to the attached drawings.

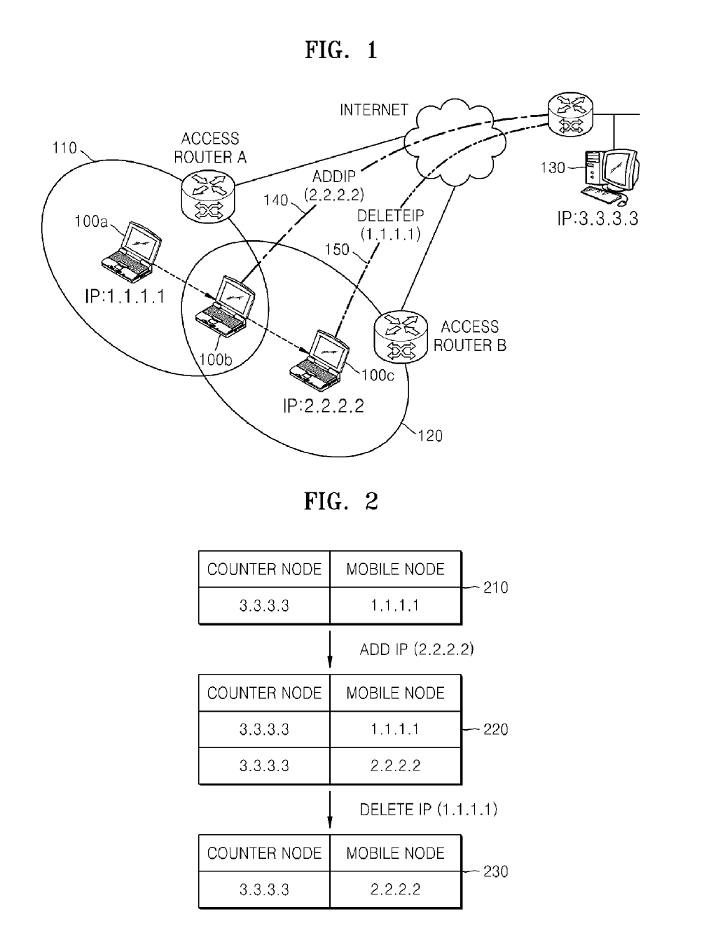

FIG. 1 illustrates the typical operation of a mobile Stream Control Transmission Protocol (mSCTP) for supporting mobility of a mobile node. FIG. 2 illustrates the change of Internet Protocol (IP) addresses when the mobile node illustrated in FIG. 1 moves into a new sub-network.

Referring to FIGS. 1 and 2, when a mobile node 100a in a sub-network 110 moves to a mobile node 100b in a new sub-network 120 and acquires a new IP address, a counter node 130 adds the new IP address to a current SCTP association using an AddIP 140. In addition, when the mobile node 100a completely moves to a mobile node 100c in the new sub-network 120, the mobile node 100c determines whether an old IP address used in the previous sub-network 110 is necessary and deletes the old IP address used in the previous sub-network 110, in which data transmission is impossible, using a DeleteIP 150 when it is determined that the old IP address is not necessary. The change of an IP address according to the positions of the mobile nodes 100a, 100b, and 100c is respectively shown in tables 210, 220, and 230 illustrated in FIG. 2.

AddIP cannot be performed until a new IP address is acquired in a network layer of a mobile node. It takes a lot of time to acquire the new IP address in the network layer and transmit the new IP address to a transport layer, which makes it difficult to support a seamless handover.

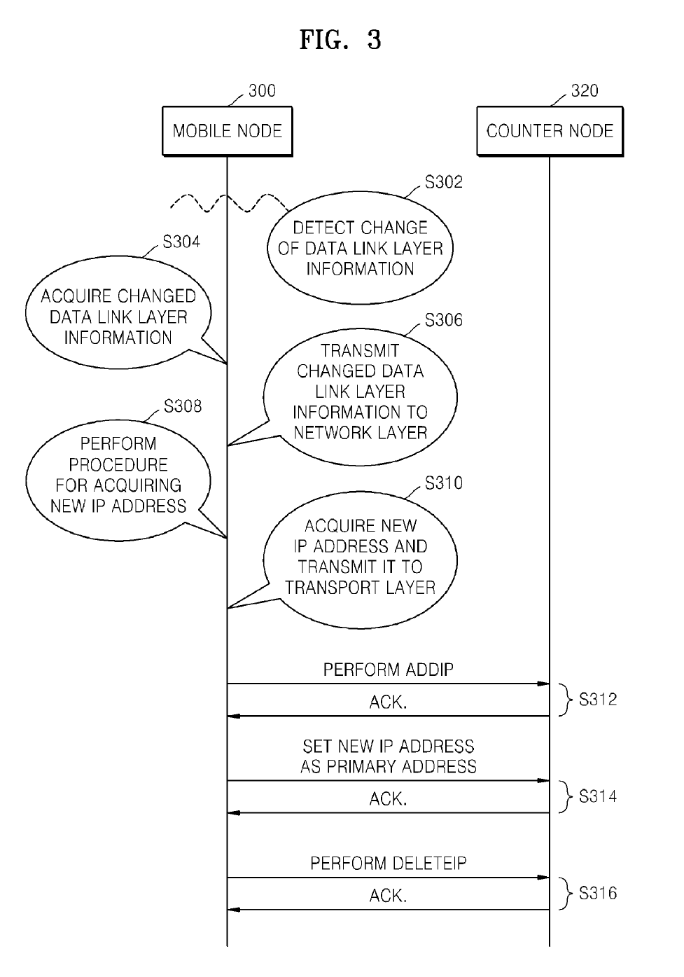

FIG. 3 is a method of supporting a seamless handover of a mobile node using the mSCTP according to an embodiment of the present invention. Referring to FIG. 3, when a mobile node moves into a new sub-network and the change of data link layer information is detected, the changed data link layer information is transmitted to a network layer.

In detail, when a mobile node 300 moves into a new sub-network in a mobile environment, the change in a data link layer is the first change that occurs. The mobile node 300 detects the change in the data link layer in operation S302 and acquires changed data link layer information in operation S304. The change of the data link layer information may be information about a connection to a new data link layer, information about a disconnection from an existing data link layer, information about link-up, or information about link-down.

In operation S306, the mobile node 300 transmits the changed data link layer information to an upper layer in order to quickly acquire an IP address in the network layer. In operation S308, the upper layer receiving the changed data link layer information in the mobile node 300 performs a procedure for acquiring an IP address in a new sub-network using the changed data link layer information.

The procedure for acquiring an IP address is a process of determining whether a change has occurred in the network layer. According to setting of network configuration, the change in the data link information may be the movement of the mobile node 300 to a new sub-network or not. In other words, even when the change in the data link layer information is detected, it is determined that the mobile node 300 has not moved into a new sub-network if a data link entity (e.g., an access point in a wireless local area network (WLAN)) after the movement of the mobile node 300 is connected with the same network entity (e.g., the same access router) as a data link entity before the movement.

When the mobile node 300 moves into the new sub-network in an IPv6 environment, the network layer transmits a router solicitation message upon receiving the changed data link layer information. Conventionally, the network layer passively waits for a router advertisement (RA) message in order to determine whether the mobile node 300 moves into a new sub-network. However, in the current embodiment of the present invention, the network layer transmits the router solicitation message immediately in order to make immediate determination on the movement into a new sub-network. Upon receiving a reply message in response to the router solicitation message, the network layer determines whether the mobile node 300 has moved into a new sub-network based on the received reply message.

Whether the mobile node 300 has moved into a new sub-network is determined based on a prefix included in the RA message received from a router. If the prefix included in the RA message is the same as a previous prefix, it is determined that the mobile node 300 has not moved into a new sub-network; otherwise, it is determined that the mobile node 300 has moved into a new sub-network.

In an IPv4, since there is no RA message or prefix, whether the mobile node 300 has moved into a new sub-network is determined based on whether IP address information possessed by the mobile node 300 is the same as newly acquired IP address information.

In operation S310, the IP address acquired for the new sub-network through the above-described operation is transmitted to a transport layer. In operation S312, the mobile node 300 performs a dynamic address configuration process in the transport layer using an mSCTP.

The dynamic address configuration process can be performed using AddIP defined in the mSCTP. The change of an IP address in the network layer directly provokes the mSCTP in the transport layer to perform AddIP. Accordingly, upon receiving a report indicating that a new IP address is acquired from the network layer, the transport layer immediately performs AddIP through the mSCTP. As a result, a handover defined in the mSCTP can be performed with improved quality.

After receiving from a counter node 320 an acknowledgement (ACK) indicating that the AddIP has been performed in operation S312, the mobile node 300 sets the new IP address as a primary address in operation S314. Thereafter, if a previous IP address is not necessary, the mobile node 300 deletes the previous IP address by performing DeleteIP according to the mSCTP in operation S316.

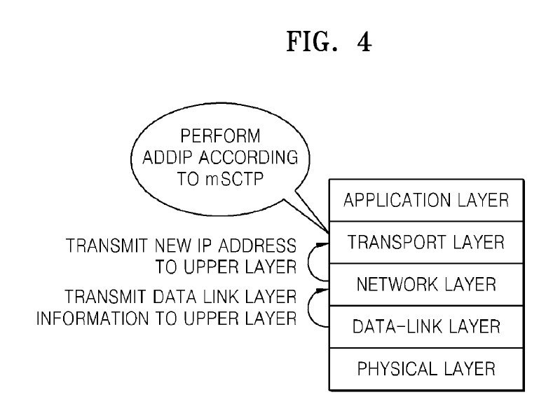

FIG. 4 illustrates a procedure of transmitting information between layers and performing a function in a mobile node, according to an embodiment of the present invention. Referring to FIG. 4, in order to reduce a handover delay time in the mobile node, a network layer quickly acquires a new IP address using data link layer information and transmits the new IP address to the mSCTP in a transport layer so that AddIP is quickly performed.

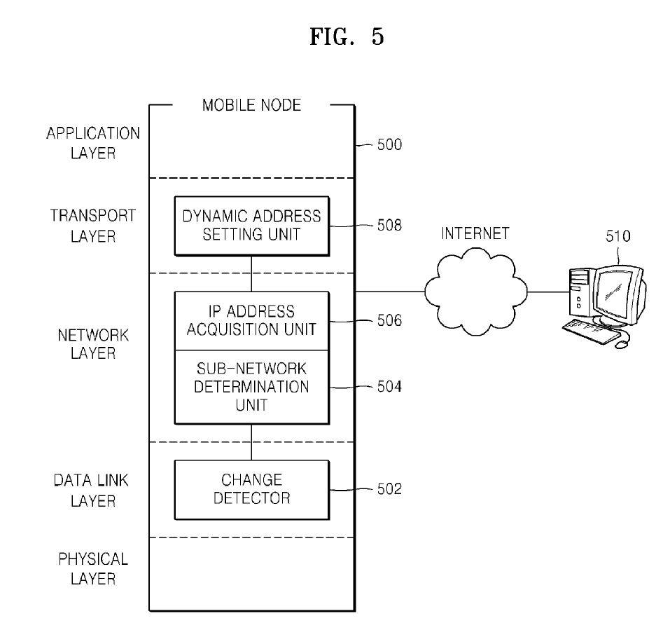

FIG. 5 illustrates a system for supporting a seamless handover of a mobile node 500 using the mSCTP according to an embodiment of the present invention. Referring to FIG. 5, the system for supporting a seamless handover of the mobile node 500 includes a change detector 502, a sub-network determination unit 504, an IP address acquisition unit 506, and a dynamic address setting unit 508.

The change detector 502 detects the change in data link layer information, which occurs when the mobile node 500 moves into a new sub-network. The data link layer information detected by the change detector 502 may be information about a connection to a new data link layer, information about a disconnection from an existing data link layer, information about link-up, or information about link-down.

The sub-network determination unit 504 determines whether the mobile node 500 has moved into a new sub-network based on the data link layer information received from the change detector 502.

Even when the change detector 502 detects the change in the data link layer information and transmits the changed data link layer information, there may not be a change in a sub-network. For example, the sub-network determination unit 504 determines that the mobile node 500 has not moved to a new sub-network when, after the movement of the mobile node 500, a new data link entity is connected with the same network as a previous data link entity before the movement occurred. In a case where the mobile node 500 moves into a new sub-network in the IPv6 environment, the sub-network determination unit 504 immediately transmits a router solicitation message as soon as receiving the changed data link layer information, without waiting for an RA message. When a reply message in response to the router solicitation message is received from a router, whether the mobile node 500 has moved into a new sub-network can be determined based on the reply message.

When the sub-network determination unit 504 determines that the mobile node 500 has moved into a new sub-network, the IP address acquisition unit 506 acquires a new IP address in the new sub-network using the changed data link layer information. When the new IP address is acquired, the dynamic address setting unit 508 changes an address of the mobile node 500 into the new IP address using the mSCTP while maintaining a session. In other words, the dynamic address setting unit 508 dynamically changes an IP address mapped in an SCTP association in order to support mobility. Thereafter, a counter node 510 can transmit data to the new IP address of the mobile node 500.

The mSCTP defines AddIP and DeleteIP which are used to perform the above-described operations. The system for supporting a seamless handover allows AddIP to be quickly performed using the data link layer information, thereby reducing a handover delay time. As a result, the mobility of the mobile node 500 can be improved.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, a handover delay occurring when a mobile node moves into a new sub-network is reduced, and therefore, mobility of the mobile node supporting a seamless handover can be supported.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A method of supporting a seamless handover of a mobile node using a mobile Stream Control Transmission Protocol (mSCTP), the method comprising:
detecting a change of data link layer information, which occurs when the mobile node moves into a new sub-network, and transmitting changed data link layer information to a network layer;
acquiring a new Internet protocol (IP) address for the new sub-network in the network layer based on the changed data link layer information; and
transmitting the new IP address to a transport layer and performing dynamic address setting in the transport layer using the mSCTP.

2. The method of claim 1, wherein the changed data link layer information is at least one selected from the group consisting of information about a connection to a new data link layer, information about a disconnection from an existing data link layer, information about link-up, and information about link-down.

3. The method of claim 1, further comprising determining that the mobile node has not moved into the new sub-network if, after the movement of the mobile node, a new data link entity is connected with the same network as a previous data link entity before the movement occurred, when the change in the data link layer information is detected.

4. The method of claim 1, wherein when the mobile node moves into the new sub-network in an IPv6 environment, the network layer transmits a router solicitation message upon receiving the changed data link layer information and determines whether the mobile node has moved into the new sub-network based on a reply message in response to the router solicitation message.

11. A computer readable recording medium for recording a program for executing the method of claim 1 on a computer.

12. A computer readable recording medium for recording a program for executing the method of claim 2 on a computer.

13. A computer readable recording medium for recording a program for executing the method of claim 3 on a computer.

14. A computer readable recording medium for recording a program for executing the method of claim 4 on a computer.

15. A computer readable recording medium for recording a program for executing the method of claim 5 on a computer.
